(19) United States
(12) Patent Application Publication
(10) Pub. No.: US 2014/0198040 A1
(43) Pub. Date: Jul. 17, 2014

(54) APPARATUS, SYSTEM AND METHOD FOR SELF-CALIBRATION OF INDIRECT POINTING DEVICES

(71) Applicant: LENOVO (SINGAPORE) PTE, LTD., New Tech Park (SG)

(72) Inventors: John Weldon Nicholson, Cary, NC (US); Kenneth Scott Seethaler, Wake Forest, NC (US)

(73) Assignee: LENOVO (SINGAPORE) PTE, LTD., New Tech Park (SG)

(21) Appl. No.: 13/743,106

(22) Filed: Jan. 16, 2013

(51) Int. Cl. G06F 3/033

(52) U.S. Cl. CPC G06F 3/033
USPC 345/157

(57) ABSTRACT

An apparatus, system, and method are disclosed for pointing device calibration. An observation module may track physical movement sensed by an indirect pointing device and record actual cursor behavior corresponding to the physical movement. An analysis module may compare the actual cursor behavior to reference cursor behavior to detect a deviation. A calibration module may adjust one or more settings of the pointing device in a manner calculated to reduce the deviation.

### BACKGROUND

1. Field

The subject matter disclosed herein relates to indirect pointing devices and more particularly relates to automatic self-calibration.

2. Description of the Related Art

It is becoming more common to use multiple pointing devices with a computer system. For instance, a system may have a trackpoint, a touchpad, a wired mouse at work, another wired mouse at home, and a portable wireless mouse used when travelling. In the future, additional indirect manipulation pointing devices will exist, such as virtual touch surfaces and gesture cameras.

Each of these devices may have different sensitivities. For example, one mouse may have a 300 dpi sensor, and another may have a 600 dpi sensor. With the common sensitivity control in use today, the higher resolution sensor moves the cursor twice as many pixels for the same physical movement.

The existing solution to this problem is the use of independent sensitivity controls for each device, requiring a separate driver or application installation, with separate configuration menus to control their sensitivity. It is not feasible to make use of general purpose interfaces and protocols that share a common sensitivity setting because the setting for one device may not be optimal for another device.

### BRIEF SUMMARY

Based on the foregoing discussion, the inventors have recognized that a long-felt unmet need exists for an apparatus, system, and method for pointing device calibration. Such an apparatus, system, and method would automate the calibration of all indirect pointing devices and provide a single point of control for customization by a user as desired.

Embodiments have been developed in response to the present state of the art, and in particular, in response to the problems and needs in the art hitherto proven intractable under currently available pointing device calibration. Accordingly, the embodiments have been developed to provide a method, apparatus, and system for pointing device calibration that overcome many or all of the above-discussed shortcomings in the art.

The apparatus to calibrate a pointing device is provided with a plurality of modules configured to functionally execute steps. These modules in the described embodiments include an observation module that tracks physical movement sensed by an indirect pointing device and records actual cursor behavior corresponding to the physical movement, an analysis module that compares the actual cursor behavior to reference cursor behavior to detect a deviation, and a calibration module that adjusts one or more settings of the pointing device in a manner calculated to reduce the deviation.

In various embodiments, the physical movement may comprise one or more of pointing, navigating, scrolling, manipulating, writing, drawing, painting, and so forth. The deviation may comprise one or more of overshoot, undershoot, slowness, lurching, repetition, or the like. The settings may comprise one or more of sensitivity, ballistics, and momentum, and so forth.

In a further embodiment, the calibration module may comprise an expert system that improves the manner of reducing the deviation through machine learning.

A system is also presented to calibrate a pointing device. The system may be embodied by the indirect pointing device, the computer and the foregoing apparatus for pointing device calibration. In particular, the system, in one embodiment, includes a support module that maintains one or more models of reference cursor behavior including at least a default model.

In one embodiment, the system may further comprise a second indirect pointing device, wherein the calibration module adjusts one or more second settings of the second pointing device in a manner calculated to reduce the deviation. In a further embodiment, the system may be multi-user, calibrating the indirect pointing device independently for each user. In various embodiments, the indirect pointing device(s) may comprise a mouse, a touchpad, a trackpoint, a joystick, a pedal, a wand, a remote, a touchscreen, and a gesture camera.

A method is also presented for calibrating a pointing device. The method in the disclosed embodiments substantially includes steps to carry out the functions presented above with respect to the operation of the described apparatus and system. In one embodiment, the method includes tracking physical movement sensed by an indirect pointing device, recording actual cursor behavior corresponding to the physical movement, comparing the actual cursor behavior to reference cursor behavior to detect a deviation, and adjusting one or more settings of the pointing device in a manner calculated to reduce the deviation.

In an embodiment, the method may include providing a training mode in which a user demonstrates the reference cursor behavior, or a user interface that enables a user to explicitly define the reference cursor behavior or explicitly control the step of adjusting.

In a further embodiment, the method may comprise filtering out cursor behavior related to extraneous physical movement. In one embodiment, filtering may comprise statistically combining historical cursor behavior. In another embodiment, filtering may comprise ignoring aimless cursor behavior.

In a further embodiment, the method also may include improving the manner of reducing the deviation through machine learning.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of the embodiments as set forth hereinafter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system of a present embodiment;

FIG. 2 is a schematic block diagram illustrating a pointing device calibration apparatus;

FIG. 3 is a schematic block diagram illustrating a possible computer hardware platform upon which present embodiments may be at least in part deployed;

FIG. 4 is a schematic block diagram of a possible computer including a software stack in which present embodiments may at least in part reside;

FIG. 5 is a schematic block diagram illustrating an embodiment of cursor sensitivity;

FIG. 6 is a schematic block diagram illustrating an embodiment of reference cursor behavior and various types of deviations therefrom;

FIG. 7 is a schematic block diagram illustrating an embodiment of cursor ballistics;

FIG. 8 is a schematic block diagram illustrating an embodiment of cursor momentum;

FIG. 9 is a schematic block diagram illustrating an embodiment of demonstrating reference cursor behavior in training mode;

FIG. 10 is a schematic block diagram that illustrates an embodiment of filtering out cursor behavior related to extraneous physical movement; and

FIG. 11 is a schematic flow chart diagram illustrating one embodiment of a method for pointing device calibration.

### DETAILED DESCRIPTION

As will be appreciated by one skilled in the art, aspects of the embodiments may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable medium(s).

Any combination of one or more computer readable medium(s) may be utilized. The computer readable medium may be a computer readable signal medium or a computer readable storage medium. The computer readable medium may be a tangible computer readable storage medium storing the computer readable code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Computer readable program code embodied on a computer readable medium may be transmitted using any appropriate medium, including but not limited to wireless, wireline, optical fiber cable, RF, etc., or any suitable combination of the foregoing.

Computer readable program code for carrying out operations for embodiments may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments. It will be understood that each block of the schematic flowchart diagrams and/or schematic block diagrams, and combinations of blocks in the schematic flowchart diagrams and/or schematic block diagrams, can be implemented by computer readable program code. These computer readable program code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

The proposed solution to the problems with the current pointing device calibration process is to change the device behavior to accommodate how the user operates the device, rather than for the user to have to change their behavior to accommodate the device. Through statistical modeling, the method may detect cursor movements that a user makes when moving a cursor to a desired location on a screen. User behavior is observed on an existing/primary input device, from which a model may be built. For example, movements observed in order to build the model may include button clicks (such as the start menu, desktop icons, send button, etc.), text selection start, rate at which the cursor moves across the screen, and so forth. Then, when a new input device is used, if the user takes longer and moves slower (“under-steers”), the sensitivity may be adjusted upwards; or if the user moves more quickly, and moves past the desired location and has to move back (“over-steers”), the sensitivity may be adjusted downwards. This method is equally applicable to mice as well as touchpads and other indirect input mechanisms.

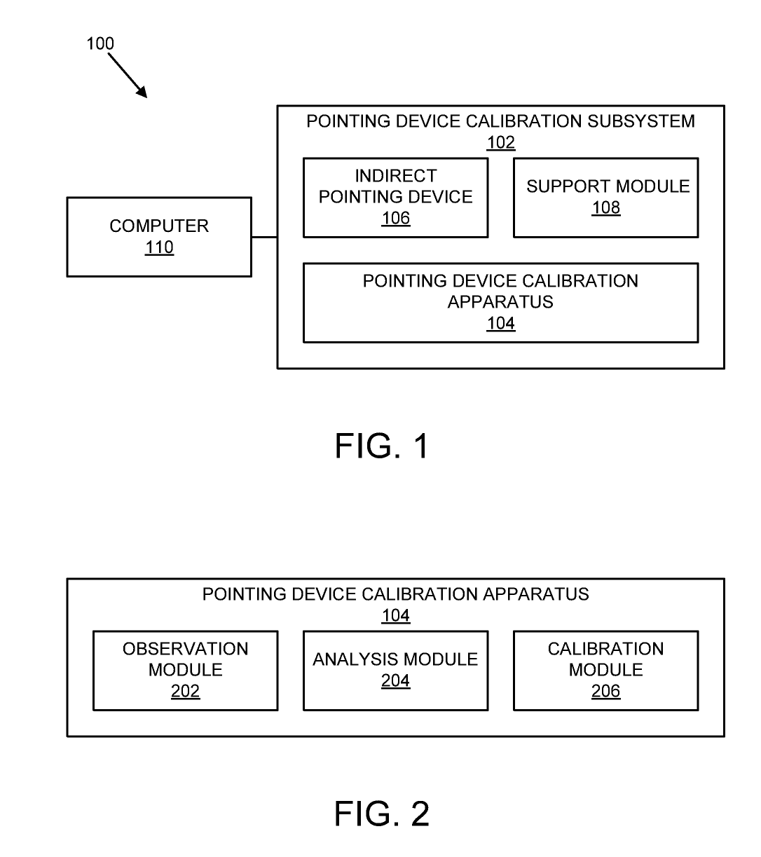

FIG. 1 is a schematic block diagram illustrating a system 100 of a present embodiment, including a computer 110 and a pointing device calibration subsystem 102. The subsystem 102 further includes a pointing device calibration apparatus 104, a indirect pointing device 106, and a support module 108. In an embodiment, the foregoing components of the subsystem 102 may be fully or partially implemented within a hardware platform and/or a software stack of the computer 110.

The apparatus 104 may automatically calibrate one or more indirect pointing devices 106 for one or more users of the system 100. Specifically, one or more additional indirect pointing devices 106 may be calibrated based upon the calibration of a first indirect pointing device 106. If the system 100 is multi-user, the apparatus 104 may calibrate each indirect pointing device 106 independently for each user.

The indirect pointing device(s) 106 may include one or more of a mouse, a touchpad, a trackpoint, a joystick, a wand, a remote, a touchscreen, a gesture camera, or the like, and may be used for pointing, navigating, scrolling, manipulating, writing, drawing, painting, and so forth.

The support module 108 may maintain one or more models of reference cursor behavior including at least a default model. Additional models may be maintained for different indirect pointing devices 106 and for different users, which may be partially or fully user-defined.

FIG. 2 is a schematic block diagram illustrating a pointing device calibration apparatus 104, including an observation module 202, an analysis module 204, and a calibration module 206. The observation module 202 may track physical movement sensed by the indirect pointing device 106 and record actual cursor behavior corresponding to the physical movement. The analysis module 204 may compare the actual cursor behavior to reference cursor behavior to detect a deviation. The calibration module 206 may adjust one or more settings of the pointing device 106 in a manner calculated to reduce the deviation.

The observation module 202 may further provide a training mode in which a user demonstrates actual cursor behavior and then approves it to become the reference cursor behavior. Alternatively, the user may simply allow the apparatus 104 to utilize one or more pre-defined models of reference cursor behavior.

The analysis module 204 may further provide a user interface that enables a user to explicitly modify or define the reference cursor behavior. The analysis module 204 may also filter out cursor behavior related to extraneous physical movement. Filtering may include statistically combining historical cursor behavior, ignoring aimless cursor behavior, and so forth.

The calibration module 206 may include an expert system that improves the manner of reducing the deviation through machine learning. The calibration module 206 may further provide a user interface that enables a user to explicitly control the step of adjusting.

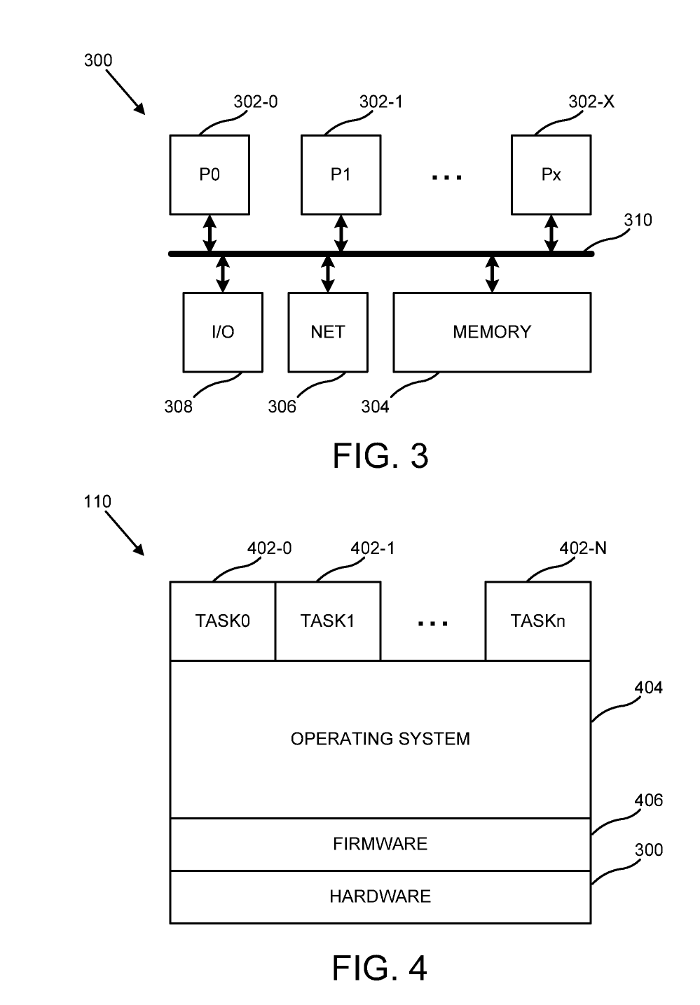

FIG. 3 illustrates a possible computer hardware platform 300 upon which present embodiments may be at least in part deployed. The hardware platform 300 may include processor(s) 302, memory 304, a network interface 306, and an I/O (Input/Output) device interface 308, connected through a bus 310.

The hardware platform 300 may be of any form factor or type, including an embedded system, a handheld, a mobile phone, a pad, a notebook, a personal computer, a minicomputer, a server, a mainframe, a supercomputer, and the like.

The processor(s) 302 may be present in any quantity, including a uniprocessor, and may have any instruction set architecture. In an embodiment, the processor(s) 302 may have one or more levels of dedicated or shared caches. Possible physical implementations may include multi-chip, single chip, multi-core, hyperthreaded processors, and the like.

The memory 304 may be of any size or organization and may include both read/write and read-only sections. It may also include both global and local sections, and may support both uniform and non-uniform access. It may incorporate memory-mapped I/O and direct memory access. It may support cache coherency, including directory-based and snoop-based protocols.

The network interface 306 may support any network protocol or architecture. It may support both wireless and hard-wired network connections. It may comprise Ethernet, Token Ring, System Network Architecture (“SNA”), and the like. In one embodiment, it may be integrated with the I/O device interface 308.

The I/O device interface 308 may be driven primarily by the processor(s) 302 or may incorporate an independent I/O processor subsystem. It may comprise Peripheral Component Interconnect (“PCI”), Small Computer System Interface (“SCSI”), Fiberchannel (“FC”), Enterprise System Connection (“ESCON”), ESCON over Fiberchannel (“FICON”), and the like. In an embodiment, it may include dedicated local I/O devices.

The bus 310 may comprise one or more of a variety of physical and logical topologies. It may be parallel or serial. It may be unidirectional or bidirectional. It may be flat or hierarchical. It may comprise a full or partial crossbar. It may comprise multiple bridged busses. In an embodiment, the bus 310 may comprise a high-speed internal network.

FIG. 4 is a diagram of a possible computer 110 including a software stack in which present embodiments may at least in part reside. The software stack may include task(s) 402, hosted on an operating system 404, enabled by firmware 406, running on a hardware platform 300 of which the configuration of FIG. 3 is representative.

The task(s) 402 may include both user- and system-level tasks. They may be interactive or batch. They may run in the foreground or background. User-level task(s) 402 may include applications, programs, jobs, middleware, and the like. System-level task(s) 402 may include services, drivers, daemons, utilities, and the like.

The operating system 404 may be of any type and version and in any state. Types may include Unix, Linux, Windows, Mac, MVS, VMS, and the like. Versions may include Windows XP, Windows Vista, and the like. States may include a degree of customization, a mode of operation, a system preparation for setup, and the like. The operating system 404 may be single-user or multi-user. It may be single-tasking or multi-tasking. In an embodiment, the operating system 404 may be real-time. In another embodiment, the operating system 404 may be embedded.

The firmware 406 may comprise microcode, which may reside in a microstore of the processor(s) 302. In an embodiment, the firmware 406 may comprise low-level software, which may reside in memory 304. In one embodiment, the firmware 406 may comprise a rudimentary operating system 404. In a further embodiment, the firmware 406 may support virtualization so as to permit the concurrent operation of multiple operating systems 404 on a hardware platform 300.

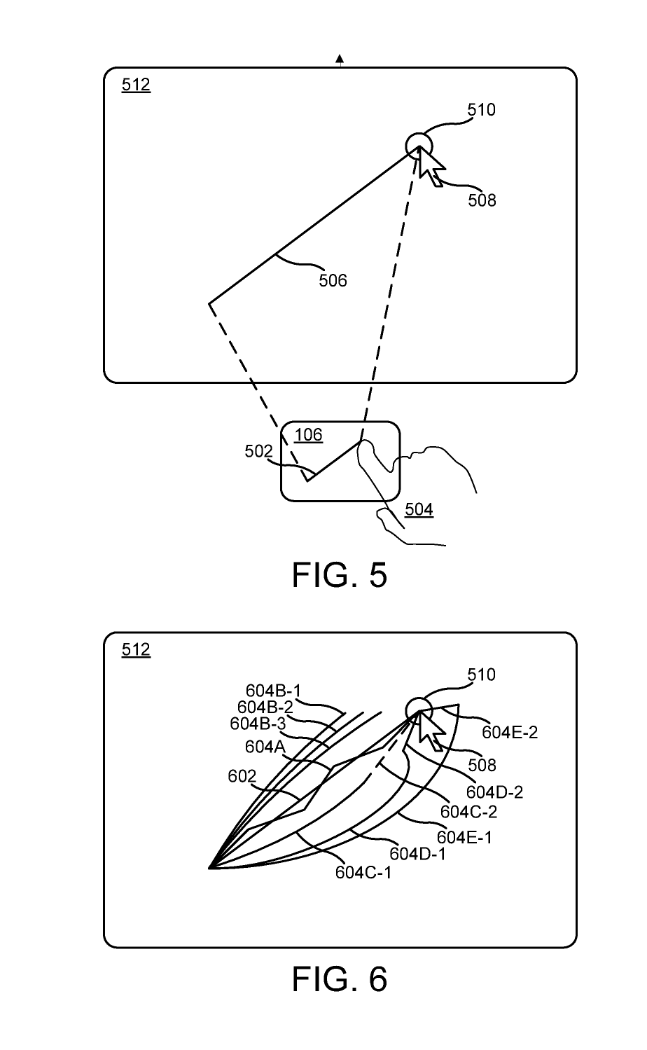

FIG. 5 is a schematic block diagram illustrating an embodiment of cursor sensitivity. The indirect pointing device 106 comprising a touchpad senses a physical movement 502 of a bodily appendage 504 comprising an index finger. The actual cursor behavior 506 of the cursor 508 as it travels to a target 510 on a display screen 512 may be tracked and recorded by the observation module 202. The target 510 may comprise an icon or other feature displayed on the screen 512. As can be seen, the actual cursor behavior 506 on the display screen 512 is congruent to the physical movement 502 across the touchpad indirect pointing device 106.

A sensitivity setting of the indirect pointing device 106 controls the ratio between the actual cursor behavior 506 and the physical movement 502. A higher sensitivity ratio results in farther travel of the cursor 508 across the display screen 512 for a given physical movement 502 of the finger 504 across the touchpad 106 than would result from a lower sensitivity ratio setting. Thus a higher sensitivity setting may move the cursor 508 more quickly, whereas a lower sensitivity setting may move the cursor 508 more accurately.

FIG. 6 is a schematic block diagram illustrating an embodiment of reference cursor behavior 602 and various types of deviations 604 therefrom, including lurching 604A, repetition 604B, slowness 604C, undershoot 604D, overshoot 604E, and so forth. The analysis module 204 may compare the deviations 604 of the actual cursor behavior 506 from the reference cursor behavior 602. Based upon that comparison, the calibration module 206 may then adjust the sensitivity and other settings of the pointing device 106 in a manner calculated to reduce the deviation 604.

With the lurching deviation 604A, the cursor 508 follows an erratic path across the display screen 512 toward the target 510, advancing in fits and starts in a jerky fashion. In one embodiment, the calibration module 206 may conclude that the cursor 508 is responding faster than expected by the user, and reduce the sensitivity setting in order to achieve a smoother response by the cursor 508.

With the repetition deviation 604B, the user may make multiple unsuccessful attempts 604B-1, 604B-2, 604B-3 to reach the target 510, perhaps getting progressively closer but failing to hit it with the cursor 508. Such a situation might arise with a spring-loaded indirect pointing device such as a joystick, or with an unsuccessful drag-and-drop operation in which the object to be moved snaps back to its last valid position. In one embodiment, the calibration module 206 may conclude that accuracy is the problem, and reduce the sensitivity setting in order to give the user a finer degree of control over positioning the cursor 508.

With the slowness deviation 604C, the cursor 508 may only travel part way 604C-1 toward the target 510 in a reasonable period of time as compared with the reference cursor behavior 602 by the analysis module 204, even though the remaining trajectory 604C-2 may appear to be accurate. In one embodiment, the calibration module 206 may conclude that the speed of the cursor 508 is insufficient, and increase the sensitivity setting in order to move the cursor farther 508 across the screen 512 for a given physical movement 502 by the user.

With the undershoot deviation 604D, the cursor 508 may fall somewhat short of the target 510 in a first movement 604D-1, requiring a course correction in a second movement 604D-2 to advance the rest of the way to the target 510. In one embodiment, the calibration module 206 may conclude that the initial distance traveled by the cursor 508 is insufficient, and increase the sensitivity setting in order to move the cursor farther 508 across the screen 512 for a given physical movement 502 by the user. In another embodiment, the calibration module 206 may conclude accuracy is the problem, and reduce the sensitivity setting in order to give the user a finer degree of control over positioning the cursor 508.

With the overshoot deviation 604E, the cursor 508 may fall somewhat beyond the target 510 in a first movement 604E-1, requiring a course correction in a second movement 604E-2 to backtrack to the target 510. In one embodiment, the calibration module 206 may conclude that the initial distance traveled by the cursor 508 is excessive, and reduce the sensitivity setting in order to move the cursor 108 a shorter distance across the screen 512 for a given physical movement 502 by the user. In another embodiment, the calibration module 206 may conclude accuracy is the problem, and likewise reduce the sensitivity setting in order to give the user a finer degree of control over positioning the cursor 508.

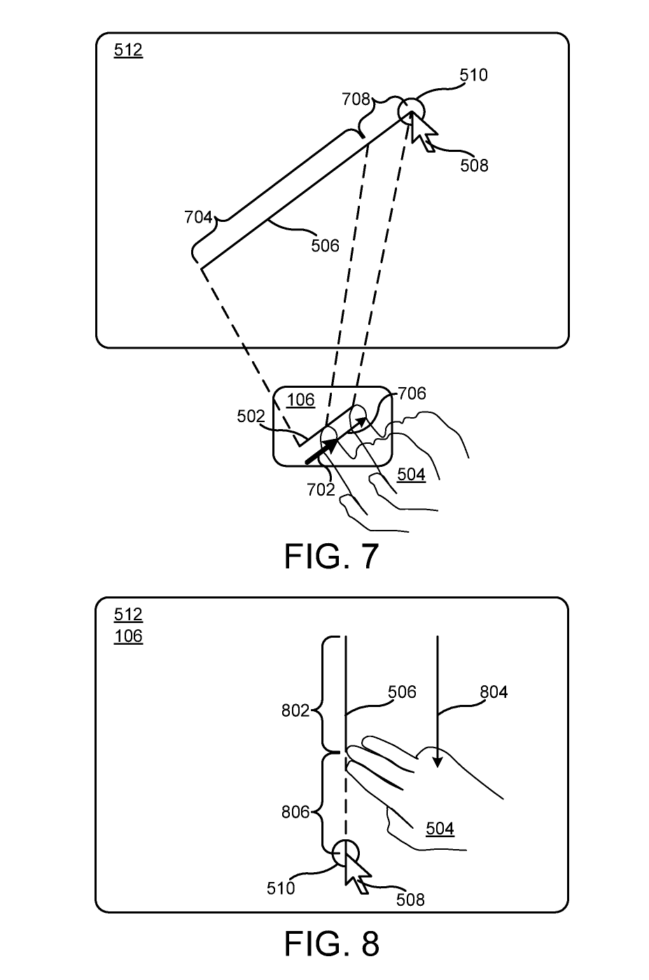

FIG. 7 is a schematic block diagram illustrating an embodiment of cursor ballistics, in which the sensitivity ratio is a function of the speed of the physical movement 502. As shown, a faster first physical movement 702 yields a higher sensitivity ratio, with the result that the cursor 508 travels a longer first distance 704 in relation to the first physical movement 702. That is followed by a slower second physical movement 706, yielding a lower sensitivity ratio, with the result that the cursor 508 travels a shorter second distance 708 in relation to the second physical movement 706, even though the second physical movement 706 may be as long as or longer than the first physical movement.

The ballistics setting may comprise a ratio of physical movement speed to sensitivity, such that a higher ballistics setting increases the ballistic effect, whereas a lower setting decreases the effect. The calibration module 206 may use the ballistics setting to strike a tradeoff between speed and accuracy of the actual cursor behavior 506, permitting the user to move the cursor 508 into the general vicinity of the target 510 more quickly, and then zero in on it more accurately. In one embodiment, the calibration module 206 may thus reduce the ballistic effect to address an overshoot deviation 604E, and increase the ballistic effect to address an undershoot deviation 604D.

FIG. 8 is a schematic block diagram illustrating an embodiment of cursor momentum, in which the actual cursor behavior 506 includes an initial cursor displacement 802 in response to a partial physical movement 804 followed by a continued cursor displacement 806 in the absence of any further physical movement 502, in which the distance of the continued cursor displacement 806 is a function of the speed of the partial physical movement 804.

The momentum setting may comprise a ratio of the speed of the partial physical movement 804 to the distance of the continued cursor displacement 806, such that a higher ratio increases the momentum effect, whereas a lower ratio decreases the effect. The calibration module 206 may use the momentum setting to strike a tradeoff between speed and accuracy of the actual cursor behavior 506, permitting the user to move the cursor 508 into the general vicinity of the target 510 more quickly, and then zero in on it more accurately if necessary. If exact precision in hitting the target 510 is not necessary, such as in perusal of a list via scrolling, the momentum effect may permit greater economy of physical movement 502 by the user. In one embodiment, the calibration module 206 may thus reduce the momentum effect to address an overshoot deviation 604E, and increase the momentum effect to address an undershoot deviation 604D.

Note that the indirect pointing device 106 of FIG. 8 is integrated with the display screen 512, as might constitute a touchscreen. Although that may imply that the pointing device 106 thus operates for the most part in a direct fashion, it serves to illustrate that indirect navigation of the cursor is still possible in such an embodiment through effects such as momentum. In another embodiment, the touchscreen may be virtual, with the display 512 being projected into the field of view of the user, employing a gesture camera as the indirect pointing device 106 to sense the physical movement 502 of the bodily appendage 504 of the user with respect to the projected image.

Note also that the bodily appendage 504 in FIG. 8 as used for pointing includes the three middle fingers, as opposed to just the index finger. In further embodiments, the bodily appendage may comprise a user's hand, foot, head, and so forth. Accordingly, the indirect pointing device 106 may also be a mouse, a trackpoint, a joystick, a pedal, a wand, a remote, or the like.

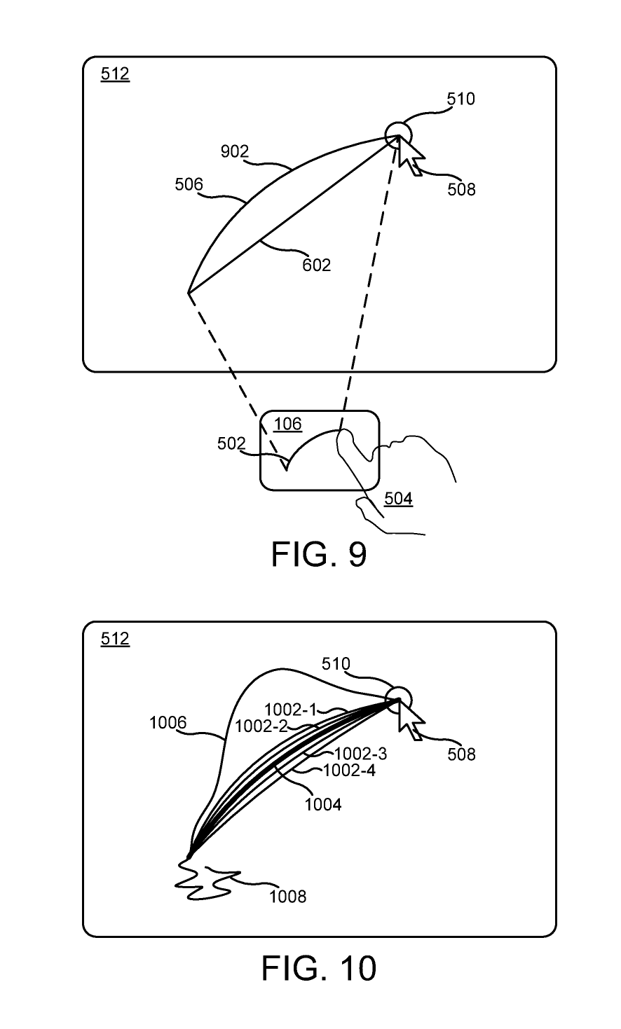

FIG. 9 is a schematic block diagram illustrating an embodiment of demonstrating reference cursor behavior 602 in training mode. For example, a straight path to the target 510 as embodied by reference cursor behavior 602 may not be representative of the actual cursor behavior 506 for a typical user. Instead, the typical physical movement 502 may be more in the form of an arc, due to rotation of the hand about the wrist or of the arm about the elbow. Furthermore, the shape of the arc may be a function of the length of the hand or the forearm of a particular user. Thus a training mode may be provided to allow an individual user to demonstrate actual cursor behavior 506 via the observation module 202 to be adopted by the analysis module 204 as a user-defined reference cursor behavior 902.

In a further embodiment, a user interface may be provided for explicitly defining the reference cursor behavior 902, including parameters such as curvature, speed, accuracy, and so forth. Such parameters may be used to define reference cursor behavior 902 from scratch and/or to modify an existing reference cursor behavior 902 as previously defined or demonstrated.

FIG. 10 is a schematic block diagram that illustrates an embodiment of filtering out cursor behavior 506 related to extraneous physical movement. For example, historical cursor behavior 1002 as tracked by the observation module 202 may be statistically combined to yield typical cursor behavior 1004. The analysis module 204 may then filter out and discard cursor behavior from statistically outlying physical movement 1006 as deviating too far from typical cursor behavior 1004 for purposes of comparison with reference cursor behavior 602 and calibration of settings. In another example, cursor behavior from aimless physical movement 1008 that meanders within a small area or fails to make meaningful progress toward the target 510 may likewise be filtered out and ignored for purposes of calibration.

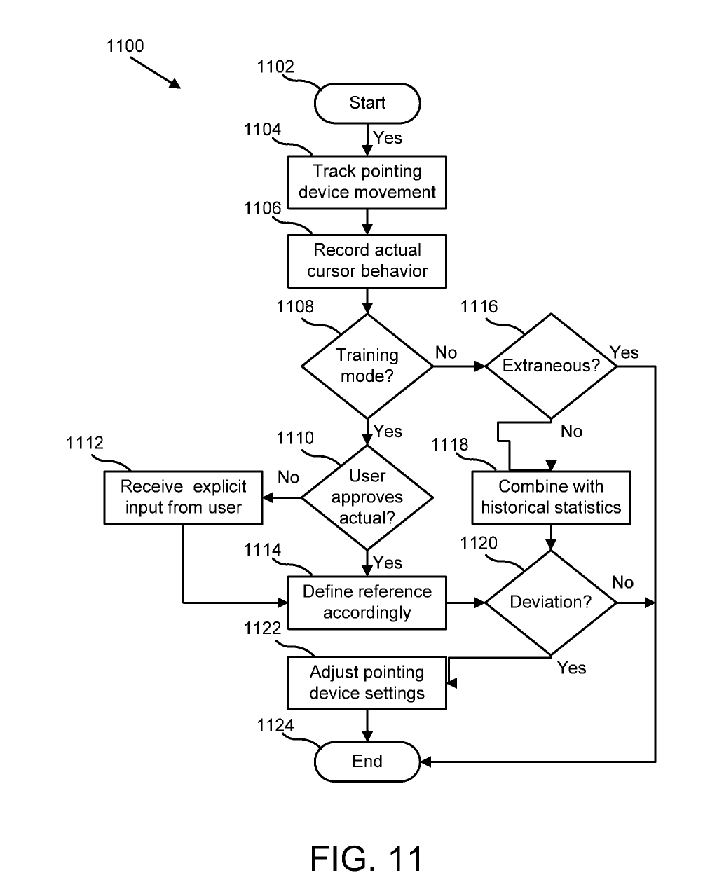

FIG. 11 is a schematic flow chart diagram illustrating one embodiment of a method for pointing device calibration. The method 1100 starts 1102 and tracks 1104 physical movement 502 sensed by an indirect pointing device 106 and records 1106 actual cursor behavior 506 corresponding to the physical movement 502.

If training mode is in effect 1108 and the user approves 1110 of the actual cursor behavior 506 then the reference cursor behavior 602 is defined 1114 as the actual cursor behavior 506. If the user does not fully approve 1110 of the actual cursor behavior 506, then the reference cursor behavior 506 is modified or redefined 1114 based upon explicit input received 1112 from the user.

If training mode is not in effect 1108 and the physical movement 502 is not extraneous 1116 then the actual cursor behavior 506 is statistically combined 1118 with historical cursor behavior 1002 and compared to reference cursor behavior 602 to detect 1120 a deviation 604. If the physical movement 502 is extraneous 1116 or there is no deviation 604 then the method 1100 ends 1124.

If a deviation 604 is detected 1120 by the analysis module 204 then the calibration module 206 adjusts 1122 the settings of the indirect pointing device 106 in a manner calculated to reduce the deviation 604, and the method 1100 ends 1124.

The adjustments 1122 may comprise applying strategies as described above such as increasing sensitivity to improve responsiveness and speed, decreasing sensitivity to improve accuracy and control, and striking a tradeoff between speed and accuracy with greater economy of physical movement 502 by regulating ballistics and/or momentum. In a further embodiment, an expert system may be employed to improve the manner of reduction through machine learning. For example, a rule-based inference engine could be seeded with the foregoing adjustment strategies, which would then evolve based on accumulated experience from actual usage, to further optimize and balance their application.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an observation module that tracks physical movement sensed by an indirect pointing device and records actual cursor behavior corresponding to the physical movement;
an analysis module that compares the actual cursor behavior to reference cursor behavior to detect a deviation; and
a calibration module that adjusts one or more settings of the pointing device in a manner calculated to reduce the deviation
wherein the observation module, the analysis module, and the calibration module comprise one or more of logic hardware and executable code, the executable code stored on one or more memory devices.

2. The apparatus of claim 1, wherein the calibration module comprises an expert system that improves the manner of reducing the deviation through machine learning.

3. The apparatus of claim 1, wherein the physical movement comprises one or more of pointing, navigating, scrolling, manipulating, writing, drawing, and painting.

4. The apparatus of claim 1, wherein the deviation comprises one or more of overshoot, undershoot, slowness, lurching, and repetition.

5. The apparatus of claim 2, wherein the settings comprise one or more of sensitivity, ballistics, and momentum.

6. A system comprising:
an indirect pointing device;
a computer having a cursor that is controlled at least in part by the indirect pointing device;
an observation module that tracks physical movement sensed by an indirect pointing device and records actual cursor behavior corresponding to the physical movement;
an analysis module that compares the actual cursor behavior to reference cursor behavior to detect a deviation; and
a calibration module that adjusts one or more settings of the pointing device in a manner calculated to reduce the deviation.

7. The system of claim 6, further comprising a support module that maintains one or more models of reference cursor behavior including at least a default model.

8. The system of claim 6, further comprising a second indirect pointing device, wherein the calibration module adjusts one or more second settings of the second pointing device in a manner calculated to reduce the deviation.

9. The system of claim 6, wherein the system is multi-user, calibrating the indirect pointing device independently for each user.

10. The system of claim 6, wherein the indirect pointing device is selected from the set consisting of a mouse, a touchpad, a trackpoint, a joystick, a pedal, a wand, a remote, a touchscreen, and a gesture camera.

11. A computer program product comprising a computer readable storage medium storing a computer readable program code executed to perform operations for self-calibration, the operations of the computer program product comprising:
tracking physical movement sensed by an indirect pointing device;
recording actual cursor behavior corresponding to the physical movement;
comparing the actual cursor behavior to reference cursor behavior to detect a deviation; and
adjusting one or more settings of the pointing device in a manner calculated to reduce the deviation.

12. The computer program product of claim 11, further comprising the operation of improving the manner of reducing the deviation through machine learning.

13. A method comprising:
tracking physical movement sensed by an indirect pointing device;
recording actual cursor behavior corresponding to the physical movement;
comparing the actual cursor behavior to reference cursor behavior to detect a deviation; and
adjusting one or more settings of the pointing device in a manner calculated to reduce the deviation.

14. The method of claim 13, further comprising improving the manner of reducing the deviation through machine learning.

15. The method of claim 13, further comprising providing a training mode in which a user demonstrates the reference cursor behavior.

16. The method of claim 13, further comprising providing a user interface that enables a user to explicitly define the reference cursor behavior.

17. The method of claim 13, further comprising providing a user interface that enables a user to explicitly control the step of adjusting.

18. The method of claim 13, further comprising filtering out cursor behavior related to extraneous physical movement.

19. The method of claim 18, wherein filtering comprises statistically combining historical cursor behavior.

20. The method of claim 18, wherein filtering comprises ignoring aimless cursor behavior.
